(19) United States
(12) Patent Application Publication
(10) Pub. No.: US 2026/0357977 A1
(43) Pub. Date: Nov. 12, 2026

(54) LIGHT BAR ASSEMBLY AND TABLE INCLUDING THE LIGHT BAR ASSEMBLY

(71) Applicant: Hangzhou Aojia Technology Co., Ltd., Hangzhou (CN)

(72) Inventor: Hongbing ZHENG, Hangzhou (CN)

(73) Assignee: Hangzhou Aojia Technology Co., Ltd., Hangzhou (CN)

(21) Appl. No.: 19/256,092

(22) Filed: Jun. 30, 2025

(30) Foreign Application Priority Data
May 9, 2025 (CN) 2025209216151

(51) Int. Cl. F21V 23/00; F21S 4/28; F21V 33/00; F21W 131/301

(52) U.S. Cl. CPC F21V 23/002; F21S 4/28; F21V 33/0012; F21W 2131/301

(57) ABSTRACT

A light bar assembly and a table including the light bar assembly are provided. The light bar assembly includes a light bar body, an adapter structure, and an electric wire. The light bar body includes a light bar and a light strip disposed in the light bar. The light bar body is detachably connected to a first end of the adapter structure. The electric wire led out from a first end of the light strip passes through the first end of the adapter structure and exits a second end of the adapter structure to be connected to a power supply terminal. A non-zero angle is formed between a first direction in which the electric wire passes through the first end of the adapter structure and a second direction in which the electric wire exits the second end of the adapter structure.

### FIELD OF THE INVENTION

The present application relates to the technical field of wiring for lighting devices, and in particular to a light bar assembly and a table including the light bar assembly.

### BACKGROUND OF THE INVENTION

Light bars are commonly used lighting devices that can be applied in various scenarios and installed in different ways. When the light bars are mounted on flat surfaces, such as tabletops, the design of the end caps at the wire outlets becomes crucial. Conventional end caps typically have a fixed, straight-through structure, which requires a pre-formed mounting slot that matches the outer diameter of the end caps to be embedded at a specific location on a tabletop. However, the conventional designs often lead to various issues during actual use.

When mounting a light bar on a tabletop, it is often necessary to create a slot in the table to embed the light bar so that its outer surface is flush with the table's surface. This approach achieves a more visually appealing look. However, in situations where the available space is limited, the electrical wire may not extend smoothly from the end cap and could be forced to bend. Such bending can lead to exposed wiring, which detracts from the overall aesthetic and creates hard-to-clean areas on the table. The hygienic blind spots are likely to accumulate dust and debris, potentially fostering bacterial growth and causing inconvenience for users.

In addition, when the electrical wire remains under prolonged compression and bending, the insulation layer is prone to cracking. Once the insulation is compromised, the risk of electric leakage increases, thereby endangering user safety. This safety hazard is particularly pronounced in humid environments, where moisture accelerates the aging and corrosion of the wire insulation, further reducing its insulating performance. Although the industry has attempted to address this issue by adding protective sleeves or similar improvements, such approaches fail to fundamentally resolve the contradiction between the rigid fixation of the wire outlet structure and the dynamic nature of actual usage environments. Accordingly, there is an urgent need to develop a new end cap design for the wire outlet that can overcome the limitations of existing technologies.

To address the issues of the conventional end caps of light bars, the new end cap should not only ensure a visually appealing installation of the light bar but also prevent wire exposure and the formation of hygienic blind spots.

### SUMMARY OF THE INVENTION

The present application provides a light bar assembly and a table including the light bar assembly.

In a first aspect, the present application provides a light bar assembly. The light bar assembly includes a light bar body, an adapter structure, and an electric wire. The light bar body includes a light bar and a light strip disposed in the light bar. The light bar body is detachably connected to a first end of the adapter structure. The electric wire led out from a first end of the light strip passes through the first end of the adapter structure and exits a second end of the adapter structure to be connected to a power supply terminal. A non-zero angle is formed between a first direction in which the electric wire passes through the first end of the adapter structure and a second direction in which the electric wire exits the second end of the adapter.

In a first embodiment of the present application, the adapter structure includes an adapter and a wire holder. A third end of the adapter is inserted into a first end of the light bar. The wire holder is fixedly connected to the adapter and clamps an outer periphery of the electric wire to maintain the electric wire in position within the adapter structure.

Preferably, a positioning rib is disposed on an outer periphery of the adapter. A positioning portion is disposed on an inner periphery of the light bar and is snap-fitted into the positioning portion to form a circumferential limiting structure.

Preferably, a light bar clearance notch is further disposed on the light bar. The light bar clearance notch is engaged with a wire outlet of the adapter to fix the electric wire.

Preferably, the light bar assembly includes at least two of the positioning ribs and at least two of the positioning portions. A number of the positioning ribs is equal to a number of the positioning portions, and the positioning portions are disposed adjacent to a respective one of the positioning ribs.

Preferably, the wire holder is a guide hole disposed in the adapter. A centerline of the wire holder is arranged at a predetermined angle relative to a centerline of the adapter to form the non-zero angle when the electric wire passes through the adapter structure and exits through the guide hole.

Preferably, the predetermined angle and the non-zero angle are right angles.

In a second embodiment of the present application, an elongated oval wiring hole is disposed on an outer surface of the adapter, on a side away from the third end. The wire holder is movably connected to the adapter through the elongated oval wiring hole. When the electric wire passes through the adapter and exits the wire holder, a position of the wire holder is changed through the elongated oval wiring hole to adjust the non-zero angle formed between the first direction and the second direction. The electric wire is routed to turn within the adapter.

In a second aspect, the present application provides a table. The table includes a table board, table legs for supporting the table board, and the light bar assembly as described in the first aspect of the present application. The light bar assembly is disposed on the table board and/or the table legs.

As described above, the light bar assembly and the table including the light bar assembly described in the present application have the following beneficial effects:

The light bar assembly and the table including the light bar assembly of the present application allow for wiring outlets on both upper and lower sides of a light strip by integrating a functional adapter structure on the light bar to satisfy practical installation requirements. Moreover, an adjustable type is provided to enable the wire outlet direction to be set at arbitrary angles, thereby enhancing aesthetic appearance, improving hygiene, and increasing operational safety. The present application not only addresses the issue of wire exposure in conventional light bars but also resolves safety concerns such as electrical leakage during installation, maintenance, and use. Meanwhile, the adapter structure and its accessories exhibit strong versatility, broad applicability, and high practical value.

### BRIEF DESCRIPTION OF DRAWINGS

FIG. 1 shows a schematic diagram of a table including a light bar assembly according to an embodiment of the present application.

FIG. 2 shows a schematic diagram of wiring of a light bar assembly on a table according to an embodiment of the present application.

FIG. 3 shows a structural schematic diagram of a light bar assembly according to an embodiment of the present application.

FIG. 4 shows an exploded view of a light bar assembly according to an embodiment of the present application.

FIG. 5 shows an exploded view of an adapter structure of a light bar assembly according to a first embodiment of the present application.

FIG. 6 shows a cross-sectional view of an adapter structure of a light bar assembly according to a first embodiment of the present application, with the cutting plane perpendicular to a first direction and parallel to a second direction.

FIG. 7 shows a cross-sectional view of a light bar assembly according to a first embodiment of the present application, with the cutting plane parallel to both a first direction and a second direction.

FIG. 8 shows a structural schematic diagram of an adapter structure having an elongated oval wiring hole of a light bar assembly according to a second embodiment of the present application.

FIG. 9 shows a top view of an adapter structure having an elongated oval wiring hole of a light bar assembly according to a second embodiment of the present application.

FIG. 10 shows a cross-sectional perspective view of an adapter structure having an elongated oval wiring hole of a light bar assembly according to a second embodiment of the present application, with the cutting plane parallel to both a first direction and a second direction.

### REFERENCE NUMERALS

1 Light bar assembly
11 Light bar body
111 Light Bar
1111 Positioning portion
1111A First positioning portion
1111B Second positioning portion
1112 Light bar clearance notch
112 Light strip
12 Adapter structure
121 Adapter
122 Wire holder
123A First end
123B Second end
123C Third end
124A First direction
124B Second direction
1211 Positioning rib
1211A First positioning rib
1211B Second positioning rib
1212 Elongated oval wiring hole
1221 Guide hole
13 Electric wire
2 Table board
3 Table leg

### DETAILED DESCRIPTION

The present application is further described below in conjunction with the accompanying drawings, but the scope of protection of the present application is not limited to that described below.

The specific embodiments are described below to illustrate the implementation of the present application, and those skilled in the art can easily understand other advantages and effects of the present application from the content disclosed in this specification. The present application can also be implemented or applied in other specific embodiments. The details provided in this description can be modified or altered in various ways based on different perspectives and applications without departing from the spirit of the present application. It should be noted that the embodiments and features of the embodiments in the present application can be combined with each other as long as there is no conflict.

It should be noted that the illustrations provided in the following embodiments are merely schematic representations to explain the basic concepts of this application. Therefore, the figures only show components related to this application and are not drawn according to the actual number, shape, and size of components in practice. The actual implementation may involve variations in the type, quantity, and proportions of the components, and the layout of the components could be more complex.

The following embodiments of the present application provide a light bar assembly and a table including the light bar assembly to address issues in the existing mounting structures of conventional light bars, where cables extend beyond the edges of tabletops, resulting in electrical safety risks due to bending fatigue. This issue occurs because the conventional end caps of the light bars have a fixed, straight-through structure, which forces cables to bend sharply when installed in confined spaces. Additionally, the present application accommodates various wiring requirements for different installation scenarios, enhancing overall aesthetics and adaptability. It also addresses the technical problem of hygienic blind spots created by gaps between the light bars and the tabletops.

The light bar assembly and the table including the light bar assembly of the present application allow for wiring outlets on both upper and lower sides of a light strip by integrating a functional adapter structure on the light bar to satisfy practical installation requirements. Moreover, an adjustable type is provided to enable the wire outlet direction to be set at arbitrary angles, thereby enhancing aesthetic appearance, improving hygiene, and increasing operational safety.

The design of the present application not only addresses the problem of exposed wiring in the conventional light bars but also mitigates safety risks, such as electric leakage, that may occur during installation, maintenance, or use of the conventional light bars.

Embodiments of the operating principle of the light bar assembly and the table including the light bar assembly will be described in detail below with reference to the accompanying drawings.

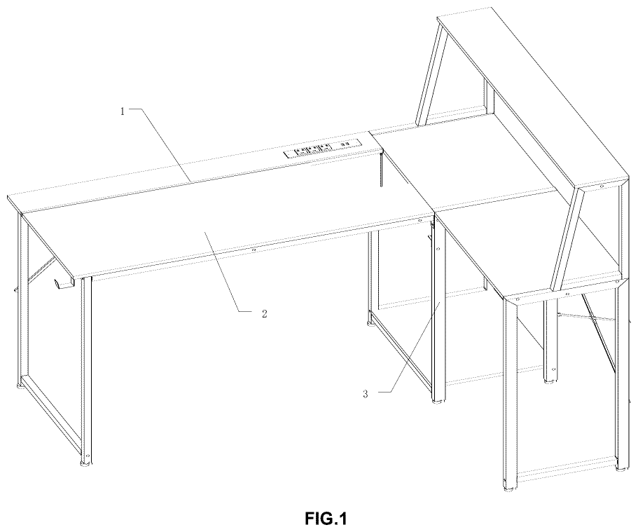

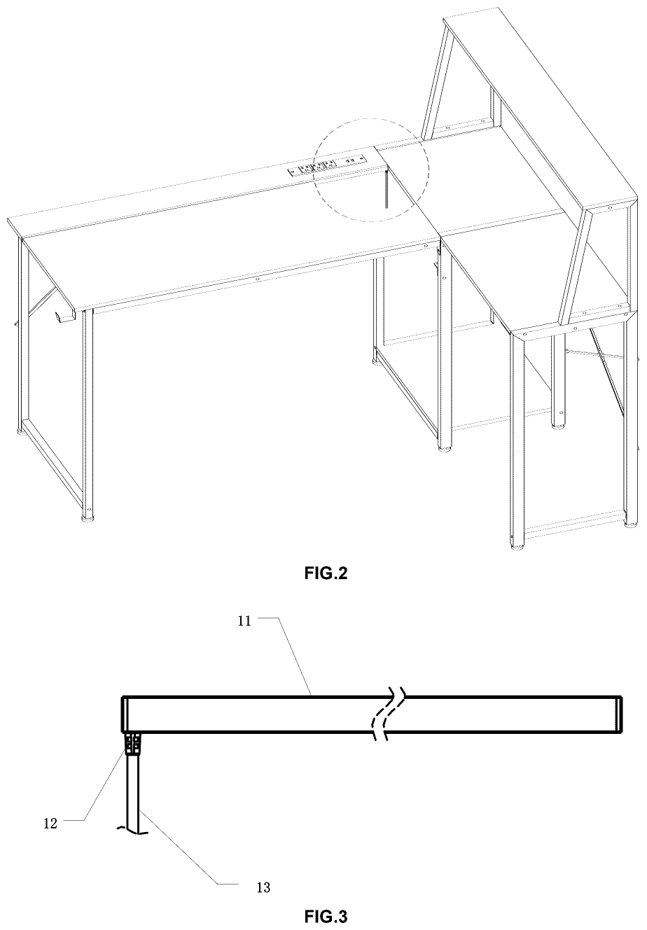

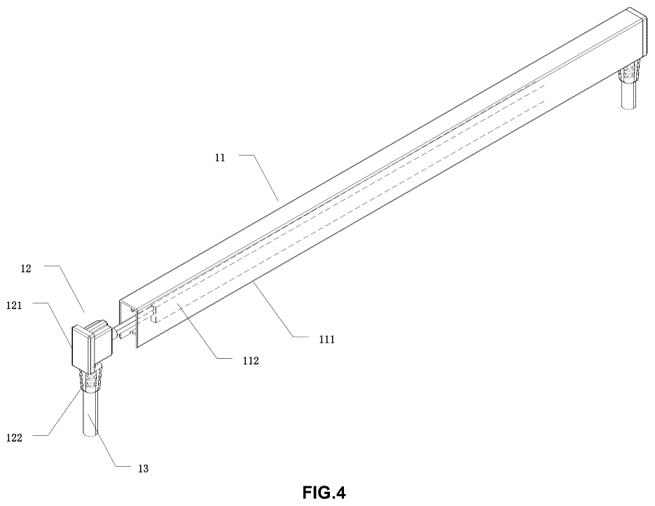

Please refer to FIGS. 1 to 4. FIG. 1 shows a schematic diagram of a table including a light bar assembly according to an embodiment of the present application. FIG. 2 shows a schematic diagram of wiring of a light bar assembly on a table according to an embodiment of the present application. FIG. 3 shows a structural schematic diagram of a light bar assembly according to an embodiment of the present application. FIG. 4 shows an exploded view of a light bar assembly according to an embodiment of the present application. As shown in FIGS. 1 to 4, the table includes a table board 2, table legs 3 for supporting the table board 2, and a light bar assembly 1.

In one embodiment, the light bar assembly 1 includes a light bar body 11, an adapter structure 12, and an electric wire 13. The light bar body 11 includes a light bar 111 and a light strip 112 disposed in the light bar 111. The adapter structure 12 includes an adapter 121 and a wire holder 122.

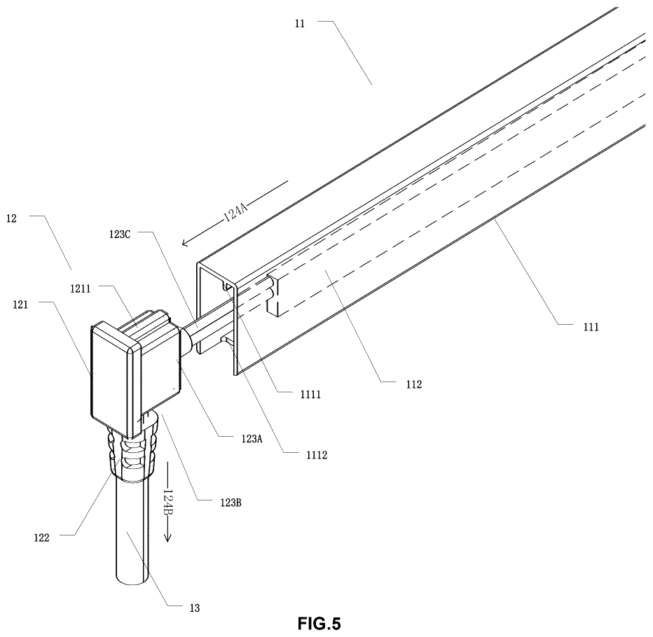

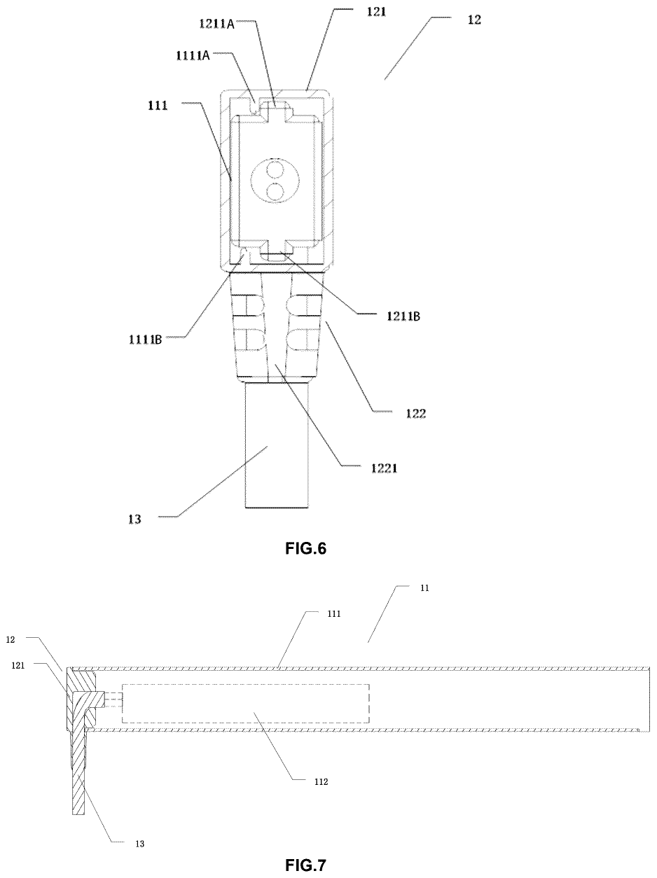

Please refer to FIGS. 5 to 7. FIG. 5 shows an exploded view of an adapter structure of a light bar assembly according to a first embodiment of the present application. FIG. 6 shows a cross-sectional view of an adapter structure of a light bar assembly according to a first embodiment of the present application, with the cutting plane perpendicular to a first direction and parallel to a second direction. FIG. 7 shows a cross-sectional view of a light bar assembly according to a first embodiment of the present application, with the cutting plane parallel to both a first direction and a second direction.

In the embodiments of the present application, the light bar body 11 is detachably connected to a first end 123A of the adapter structure 12. The electric wire 13 led out from a first end of the light strip 112 passes through the first end 123A of the adapter structure 12 and exits a second end 123B of the adapter structure 12 to be connected to a power supply terminal. A non-zero angle is formed between a first direction in which the electric wire 13 passes through the first end 123A of the adapter structure 12 and a second direction in which the electric wire 13 exits the second end 123B of the adapter structure 12.

In the first embodiment, the adapter structure 12 includes the adapter 121 and the wire holder 122. A third end 123C of the adapter 121 is inserted into a first end of the light bar 111. The wire holder 122 is fixedly connected to the adapter 121 and clamps an outer periphery of the electric wire 13 to maintain the electric wire 13 in position within the adapter structure 12.

Specifically, the third end 123C of the adapter 121 is inserted into the first end of the light bar 111, and an end portion at a first end of the light bar body 11 is connected to the first end 123A of the adapter structure 12. The light strip 112 is disposed in the light bar body 11. The electric wire 13 led out from an end portion of the light strip 112, passes through the adapter structure 12, and exits the second end 123B of the adapter structure 12 at a non-zero angle, and is ultimately connected to a power socket, thereby satisfying the actual power supply requirements of the light bar.

That is, when the third end 123C of the adapter 121 is inserted into the first end of the light bar 111, the electric wire 13 led out from the light strip 112 in the light strip body 11 passes through the first end 123A of the adapter structure 12, travels along an internal channel, and exits the second end 123B of the adapter structure 12 to connect with the power supply terminal. In this case, the non-zero angle is formed between the first direction 124A in which the electric wire 13 passes through the first end 123A of the adapter structure 12 and the second direction 124B in which the electric wire 13 passes through the second end 123B of the adapter structure 12. The non-zero angle can be adjusted according to the specific mounting situation.

In one embodiment, a positioning rib 1211 is disposed on an outer periphery of the adapter 121, and a positioning portion 1111 is disposed on an inner periphery of the light bar 111. The positioning rib 1211 is snap-fitted into the positioning portion 1111 to form a circumferential limiting structure. In one embodiment, at least two of the positioning ribs 1211 and at least two of the positioning proportions 1111 are provided. A number of the positioning ribs 1211 is equal to a number of the positioning portions 1111. The positioning portions 1111 are disposed adjacent to a respective one of the positioning ribs 1211.

The light bar 111 is further provided with a light bar clearance notch 1112. The light bar clearance notch 1112 is engaged with a wire outlet of the adapter 121 to fix the electric wire 13.

Preferably, in this embodiment, two positioning ribs 1211 and two positioning portions 1111 are provided.

Specifically, the two positioning ribs 1211 include a first positioning rib 1211A and a second positioning rib 1211B, respectively disposed on a top and a bottom of the adapter 121. The two positioning portions 1111 include a first positioning portion 1111A and a second positioning portion 1111B, respectively disposed on two inner walls of the light bar 111. The first positioning portion 1111A is engaged with the first positioning rib 1211A, and the second positioning portion 1111B is engaged with the second positioning rib 1211B, thereby enabling vertical limiting of the adapter 121 and the light bar 111. Meanwhile, the light bar clearance notch 1112 is disposed on the light bar 111 at a position corresponding to the second end 123B of the adapter structure 12, at which the adapter 121 is connected to the wire holder 122. The light bar clearance notch 1112 is engaged with the wire outlet of the adapter 121 to achieve lateral limiting. Furthermore, an end step is provided on the adapter 121 to provide front-to-back limiting between the adapter 121 and the light bar 111. Through the combination of the above structure, the light bar body 11 and the adapter structure 12 are safely and securely mounted and fixed.

That is, when the light bar body 11 is connected to the adapter structure 12, the first positioning portion 1111A is engaged with the first positioning rib 1211A, and the second positioning portion 1111B is engaged with the second positioning rib 1211B. A connection position between the adapter 121 and the wire holder 122 is engaged with the light bar clearance notch 1112 of the light bar body 11, thereby completing the engagement between the adapter 121 and the light bar 111.

In summary, when the adapter structure 12 is connected to the light bar 111, the vertical limiting of the adapter 121 is provided by the positioning ribs 1211 positioned at the top and the bottom of the adapter 121, the lateral limiting of the adapter 121 at the end portion of the light bar body 11 is provided by the positioning portions 1111 disposed on upper and lower inner walls of the first end of the light bar body 11, and the front-to-back limiting of the adapter 121 is provided by the end step on the adapter 121. Furthermore, the light bar 111 and the adapter 121 are bonded with adhesive to ensure a secure assembly without any looseness during use. Meanwhile, to address potential interference between the wire holder 122 and the light bar 111, the light bar clearance notch is provided on the light bar 111 to facilitate smooth and unobstructed wire routing. Moreover, the light bar assembly 1 also effectively prevents gaps between the light bar 111 and the tabletop, thereby eliminating potential hygiene blind spots that are difficult to clean.

It should be noted that, in this embodiment, the positioning ribs 1211, in cooperation with the positioning portions 1111, are used to connect and fix the light bar 111 and the adapter 121. Preferably, in this embodiment, the positioning portions 1111 are implemented as limiting plates, but are not limited to this structure. According to the structure of the positioning ribs 1211, the positioning portions 1111 may be implemented as limiting plates, or may use a locating groove structure to cooperate with the positioning ribs 1211 for positioning. Therefore, the structures of the positioning ribs 1211 and the positioning portions 1111 in the present application can be selected according to the specific features of the adapter structure 12.

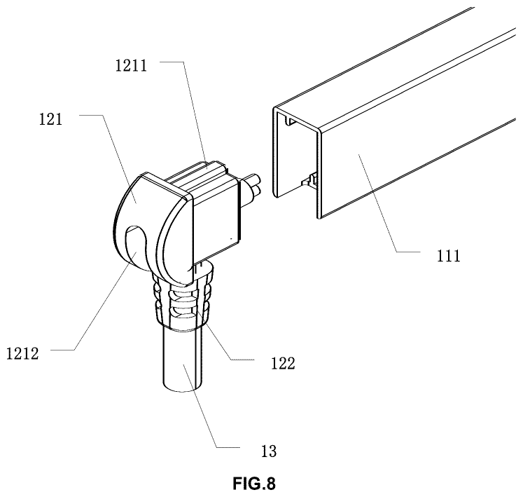

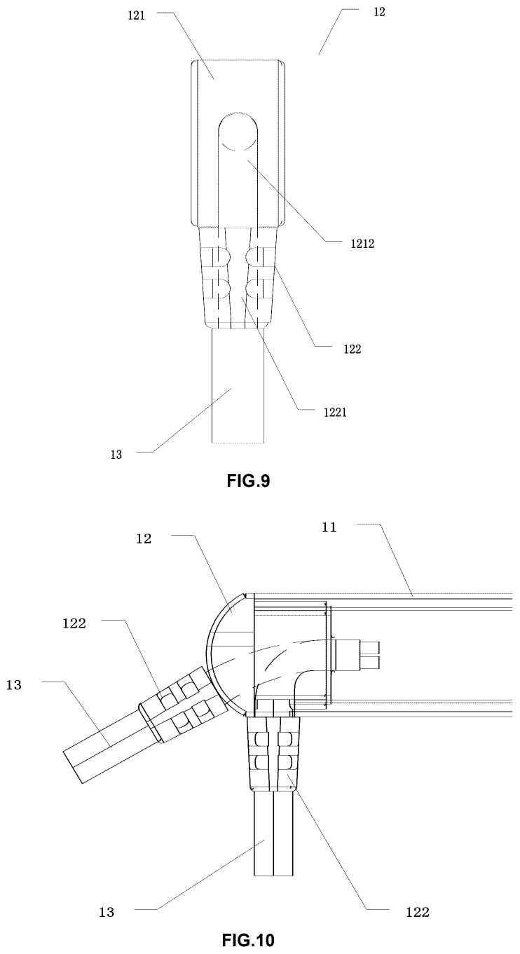

Please refer to FIGS. 8 to 10. FIG. 8 shows a structural schematic diagram of an adapter structure having an elongated oval wiring hole of a light bar assembly according to a second embodiment of the present application. FIG. 9 shows a top view of an adapter structure having an elongated oval wiring hole of a light bar assembly according to a second embodiment of the present application. FIG. 10 shows a cross-sectional perspective view of an adapter structure having an elongated oval wiring hole of a light bar assembly according to a second embodiment of the present application, with the cutting plane parallel to both a first direction and a second direction.

In one embodiment, the wire holder 122 is implemented as a guide hole 1221 disposed in the adapter 121. A centerline of the wire holder 122 is arranged at a predetermined angle relative to a centerline of the adapter 121, so that the non-zero angle is formed when the electric wire 13 passes through the adapter structure 12 and exits the guide hole 1221. The predetermined angle and the non-zero angle are right angles.

Please continue to refer to FIGS. 5 to 10.

In the second embodiment, an elongated oval wiring hole 1212 is disposed on an outer surface of the adapter 121, on a side away from the third end 123C. The wire holder 122 is movably connected to the adapter 121 through the elongated oval wiring hole 1212. When the electric wire 13 passes through the adapter 121 and exits the wire holder 122, a position of the wire holder 122 is changed through the elongated oval wiring hole 1212 to adjust the non-zero angle formed between the first direction 124A and the second direction 124B. The electric wire 13 is routed to turn within the adapter 121.

Specifically, the elongated oval wiring hole 1212 is disposed on a housing surface of the adapter 121, on the side away from the third end 123C. The guide hole 1221 is disposed in the wire holder 122. The electric wire 13 passes through the first end 123A of the adapter structure 12 along the first direction 124A and the internal channel of the adapter 121, exits the second end 123B of the adapter structure 12 through the guide hole 1221 disposed in the wire holder 122 along the second direction 124B, and is ultimately connected to the power supply terminal. At this time, the non-zero angle is present in an internal cross-section of the adapter structure 12.

That is, at this time, the guide hole 1221 is disposed in the adapter structure 12 with the centerline of the guide hole 1221 arranged at a 90°angle relative to centerline of the adapter 121. The electric wire 13 passes through the third end 123C of the adapter 121 at a first side surface of the adapter 121, and exits the wire holder 122 at a bottom portion of the adapter structure 12, thereby achieving a wire outlet direction of the electric wire 13 perpendicular to the light bar body 11. Therefore, the electric wire 13 can achieve a safe power supply by turning internally.

Furthermore, when the non-zero angle is not a right angle, the electric wire 13 passes through the adapter 121 and exits the wire holder 122 along a direction of the guide hole 1221 to be connected to the power supply terminal. Then, according to actual installation needs, the wire holder 122 is rotated along a track direction of the elongated oval wiring hole 1212 to adjust to a desired installation angle, thereby ensuring electrical safety and avoiding issues such as surface cracking, electrical leakage, and increased safety risks caused by prolonged compression and bending.

Therefore, it can be seen that a 90° angle configuration of the adapter 121 is the conventional standard, suitable for vertical wiring applications. However, in practical use scenarios, various installation angles such as 45° and 120° may also be employed. Therefore, the adapter 121 is designed to further include the elongated oval wiring hole 1212, which penetrates a second side surface and a bottom surface of the adapter 121. Additionally, the light bar clearance notch 1212 is provided at the first end of the light bar 111. The wire outlet direction of the electric wire 13 can be adjusted by rotating the wire holder 122 along an arcuate surface of the adapter 121, thereby enhancing the flexibility of installation.

The following describes the installation process of the light bar assembly and the table including the light bar assembly by way of example.

The adapter structure is disposed at the first end of the light bar, and the light strip capable of emitting light is disposed in the light bar.

During installation of the light bar assembly, the electric wire is led out from the first end of the light strip, routed through the adapter structure with a 90° bend to change the conventional horizontal wire outlet to a vertical outlet. The electric wire is then routed out of the wire holder and ultimately connected to the power socket, thereby satisfying the power supply requirements of the light bar in practical use.

Furthermore, according to the actual installation position, the installation angle may be adjusted to a non-vertical orientation through the elongated oval wiring hole disposed on the adapter structure. Meanwhile, according to the installation position of the light bar on the table, the wire holder is rotated along the elongated oval wiring hole to adjust the angle between the centerline of the wire holder and the centerline of the adapter, thereby enabling arbitrary adjustment of the wire outlet direction and completing the installation of the light bar on the table.

It can be seen that the light bar assembly provided in the present application adopts a multi-angle wire outlet structural design. This structure enables flexible wiring according to the actual installation position, facilitates convenient installation, provides high overall structural strength, and avoids safety issues caused by wire damage during use. In addition, the service life of the light bar is also improved.

In summary, the light bar assembly and the table including the light bar assembly of the present application allow for wiring outlets on both upper and lower sides of a light strip by integrating a functional adapter structure on the light bar to satisfy practical installation requirements. Moreover, an adjustable type is provided to enable the wire outlet direction to be set at arbitrary angles, thereby enhancing aesthetic appearance, improving hygiene, and increasing operational safety. The present application not only addresses the issue of wire exposure in conventional light bars, but also resolves safety concerns such as electrical leakage during installation, maintenance, and use. Meanwhile, the adapter structure and its accessories exhibit strong versatility, broad applicability, and high practical value.

The embodiments described above serve merely as illustrative examples of the principles and effects of the present application, and are not intended to serve as limitations on the invention. Persons skilled in the art may modify or alter these embodiments without departing from the spirit and scope of the present application. Therefore, any equivalent modifications or alterations made by those skilled in the art, which are consistent with the spirit and technical concepts disclosed in the present disclosure, shall still fall within the scope of the claims of the present application.

1. A light bar assembly comprising:
a light bar body comprising a light bar and a light strip disposed in the light bar;
an adapter structure having a first end detachably connected to the light bar body. wherein the adapter structure comprises an adapter and a wire holder, the adapter having a third end inserted into a first end of the light bar, and wherein a guide hole is disposed in the wire holder;
an electric wire led out from a first end of the light strip, passing through the first end of the adapter structure and exiting a second end of the adapter structure to be connected to a power supply terminal;
wherein the electric wire passes through the first end of the adapter structure along a first direction and an internal channel of the adapter, is routed to turn within the adapter, and exits the second end of the adapter structure through the guide hole along a second direction; and
wherein a non-zero angle is formed between the first direction in which the electric wire passes through the first end of the adapter structure and the second direction in which the electric wire exits the second end of the adapter structure.

2. The light bar assembly according to claim 1, wherein
the wire holder is fixedly connected to the adapter and clamps an outer periphery of the electric wire to maintain the electric wire in the adapter structure.

3. The light bar assembly according to claim 1, further comprising:
a positioning rib disposed on an outer periphery of the adapter; and
a positioning portion disposed on an inner periphery of the light bar and snap-fitted into the positioning rib to form a circumferential limiting structure.

4. The light bar assembly according to claim 3, further comprising:
a light bar clearance notch disposed on the light bar;
wherein the light bar clearance notch is engaged with a wire outlet of the adapter to fix the electric wire.

5. The light bar assembly according to claim 3, further comprising at least two of the positioning ribs and at least two of the positioning portions, wherein a number of the positioning ribs is equal to a number of the positioning portions, and the positioning portions are disposed adjacent to a respective one of the positioning ribs.

6. The light bar assembly according to claim 2, wherein a centerline of the wire holder is arranged at a predetermined angle relative to a centerline of the adapter to form the non-zero angle when the electric wire passes through the adapter structure and exits through the guide hole.

7. The light bar assembly according to claim 6, wherein the predetermined angle and the non-zero angle are right angles.

8. The light bar assembly according to claim 7, further comprising:
an elongated oval wiring hole disposed on an outer surface of the adapter, on a side away from the third end;
when the electric wire passes through the adapter and exits the wire holder, a position of the wire holder is changed through the elongated oval wiring hole to adjust the non-zero angle formed between the first direction and the second direction.

9. A table, comprising:
a table board;
table legs for supporting the table board; and
the light bar assembly according to claim 1 disposed on the table board and/or the table legs.
